(19) United States
(12) Patent Application Publication
(10) Pub. No.: US 2021/0070646 A1
(43) Pub. Date: Mar. 11, 2021

(54) PRODUCTION DEVICE AND PRODUCTION METHOD FOR SINGLE CURVED TEMPERED GLASS

(71) Applicant: Luoyang Northglass Technology Co., LTD, Henan (CN)

(72) Inventor: Jun-Feng HAN, Henan (CN)

(73) Assignee: Luoyang Northglass Technology Co., LTD, Henan (CN)

(21) Appl. No.: 16/961,470

(22) PCT Filed: Jan. 18, 2018
(86) PCT No.: PCT/CN2018/000021

§ 371 Date: Jul. 10, 2020

(51) Int. Cl. C03B 23/025; C03B 27/044

(52) U.S. Cl. CPC C03B 23/0256; C03B 27/0442; C03B 23/0258

(57) ABSTRACT

A production device and production method for single curved tempered glass. Glass to be processed is heated in a heating section to a temperature required for a glass bending and tempering process; under the combined transfer of a ceramic roller group of the heating section and a forming roller group of a forming section, the heated glass enters the forming section, each roller of the forming roller group of the forming section being in the respective initial state, and under the action of gravity or other external forces, the glass is closely attached to the forming roller group and is then pre-formed accordingly; each roller of the forming roller group is bent from its initial state to a final state, and the softened glass after heating is, under the action of gravity or other external forces, closely attached to the forming roller group and is then formed accordingly; and air blowing and cold quenching are carried out until the formation and tempering of the glass are finished, thus obtaining a single curved tempered glass product.

### TECHNICAL FIELD

The present disclosure relates to the technical field of tempered glass production, in particular to a production device and a method for bent and tempered glass.

### BACKGROUND

At present, there are three main methods for producing single curved tempered glass: a synchronous bending method, an asynchronous bending method, and a sequential forming method. When producing single curved tempered glass with a height greater than 5000 mm using synchronous bending method, the front end of the glass will have a blast defect and even burst. The asynchronous bending method can be used when producing single curved tempered glass with a height not greater than 5000 mm, the defect of ruptured glass front end can be avoided, however, the overall forming is difficult, even causing burst. The sequential forming method can be well applied when producing single curved tempered glass with a height not greater than 5000 mm, but the device needs to increase the forming section, the cost is larger, and the device occupies more production space.

According to the above analysis of existing production methods of single curved tempered glass, the current methods have the contradictions in solving following problems: rupture of glass front end, forming defects, device cost and production space occupied, these problems cannot be easily compromised. There is a need for a production method for producing single curved tempered glass that can solve the problems in quality defects causing front end rupture and in forming of the product of the single curved tempered glass; the method should be low in cost and save production space at the same time.

### SUMMARY OF THE INVENTION

The object of the present disclosure is to solve the problems existing in current production technology of single curved tempered glass, and to reveal a new production device and production method for producing single curved tempered glass, with which the problem of defects causing the front end rupture, and the problem of forming of the product of the single curved tempered glass, can be solved, at the same time the cost is low, and the production space can be saved.

The technical solution adopted by the present disclosure is:

The invention relates to a production device for single curved tempered glass, sequentially comprising a heating section and a forming section in accordance with a process sequence: the heating section is provided with a ceramic roller table set and the forming section is provided with a forming roller table set, wherein their technical features are:

The forming roller table set comprises two portions: an upstream portion close to the heating section and a downstream portion farther away from the heating section;

The upstream portion comprises n roller tables, which are respectively marked as the 1^{st}, 2^{nd}, 3^{rd}, . . . , n−1^{st}, n^{th} roller tables according to each roller table's distance to the heating section from near to distant; the downstream section comprises m roller tables, which are respectively marked as the 1^{st}, 2^{nd}, 3^{rd}, . . . , m−1^{st}, m^{th} roller tables according to each roller table's distance from the heating section from near to distant; each roller table can be bent from an initial state to a final state;

The initial state of the Pt roller table in the upstream portion is straight and is parallel with ceramic roller tables in the ceramic roller table set of the heating section, and the initial state of the n^{th} roller table in the upstream portion is bent so that an upper generatrix of the n^{th} roller table has fitted, or has not yet fitted, a shape of a lower surface of a product of the single curved tempered glass. the initial state of the 2^{nd}, 3^{rd}, . . . , n−1^{st} roller tables in the upstream portion increases respectively gradually from the initial state of the 1^{st} roller table to the initial n^{th} roller table in the upstream portion. The initial states of the 1^{st}, 2^{nd}, 3^{rd}, . . . , m−1^{st}, m^{th} roller tables in the downstream portion are the same as the initial state of the n^{th} roller table in the upstream portion; the final states of the 1^{st}, 2^{nd} 3^{rd}, . . . , n−1^{st}, n^{th} roller tables in the upstream portion, and the final states of the 1^{st}, 2^{nd}, 3^{rd}, . . . , m−1^{th}, m^{th} roller tables in the downstream portion, are all bent so that an upper generatrix of each roller table has fitted the shape of the lower surface of the product of single curved tempered glass.

Said production device for producing single curved tempered glass, wherein a length of said upstream portion is not greater than 8000 mm.

Said production device for producing single curved tempered glass, wherein the number m of the m roller tables in the downstream portion is 0, that is, the forming roller table set does not comprises the downstream portion, and only comprises the upstream portion.

Said production device for producing single curved tempered glass, wherein the product of said single curved tempered glass is a part of a cylindrical surface, wherein a radius of an outer circular surface in the cylindrical surface is R. The initial state of the n^{th} roller table of said upstream portion, and the initial states of the 1^{st}, 2^{nd}, 3^{rd}, . . . , m−1^{st}, m^{th} roller tables are all bent so that an upper generatrix of each roller table is in a shape of an arc with a radius of r; the final states of the 1^{st}, 2^{nd}, 3^{rd}, . . . , n−1^{st}, n^{th} roller tables in said upstream portion, and the final states of the 1^{st}, 2^{nd}, 3^{rd}, . . . , m−1^{st}, m^{th} roller tables in the downstream portion are all bent so that an upper generatrix of each roller table is in a shape of an arc with a radius of R; r is not smaller than R.

The invention relates to a production method for producing single curved tempered glass, wherein the method applying aforementioned production device for producing single curved tempered glass for a positive bending production or a reverse bending production are adopted, wherein following steps are comprised:

Step 1) heating: that is, a glass is heated in the heating section to a temperature required by a glass bending and tempering process, and is softened;

Step 2) transferring: that is, the glass softened after heating, under a jointly conveyance by the ceramic roller table set of the heating section and the forming roller table set of the forming section, enters the forming section, in which each roller table in the upstream portion and the downstream portion is in its initial state. At the same time, under the action of gravity or other external force, the glass softened after heating is closely appressed to the upper generatrix of each roller table in the upstream portion and the downstream portion, and the glass softened after heating is pre-formed accordingly;

Step 3) bending: that is, each roller table in the upstream portion and the downstream portion is bent from its initial state to its final state, and the glass softened after heating is closely appressed to an upper generatrix of each of the roller tables in the upstream portion and the downstream portion under an action of gravity or other external force, and the glass softened after heating being formed;

Step 4) cold quenching: that is, cold quenching by blowing air until the glass is fully formed and is tempered so as to obtain a product of single curved tempered glass.

The beneficial effects of the present disclosure are that the production device and the production method of the single curved tempered glass are disclosed, the problem of the quality defects of the front end rupture and that in the forming of the product of the single curved tempered glass is solved, the cost is low, and the production space is saved.

### BRIEF DESCRIPTION OF THE DRAWINGS

FIG. 1 is a schematic structural view of a device of the first embodiment of the present disclosure;

FIG. 2 is a schematic view showing the state of completion of transfer process of the device of the first embodiment of the present disclosure;

FIG. 3 is a schematic view showing a state in which a bending process of the device of the first embodiment of the present disclosure is completed;

FIG. 4 is a cross sectional A-A view of FIG. 1;

FIG. 5 is a cross sectional A-A view of FIG. 2;

FIG. 6 is a cross sectional A-A view of FIG. 3;

FIG. 7 is a schematic structural view of a device of the second embodiment of the present disclosure;

FIG. 8 is a schematic diagram showing the completed state of transfer process of device of the second embodiment according to the present disclosure;

FIG. 9 is a schematic diagram showing the completed state of bending process of device of the second embodiment according to the present disclosure;

FIG. 10 is a cross sectional A-A view of FIG. 7;

FIG. 11 is a cross sectional A-A view of FIG. 8;

FIG. 12 is a cross sectional A-A view of FIG. 9; Description of reference numerals: I—heating section, II—forming section; i—upstream section, u—downstream section; 1—ceramic roller table set, 2—glass, 3—forming roller table set.

### DETAILED DESCRIPTION OF THE EMBODIMENTS

The present disclosure will be further described below in combination with specific embodiments.

### The First Embodiment

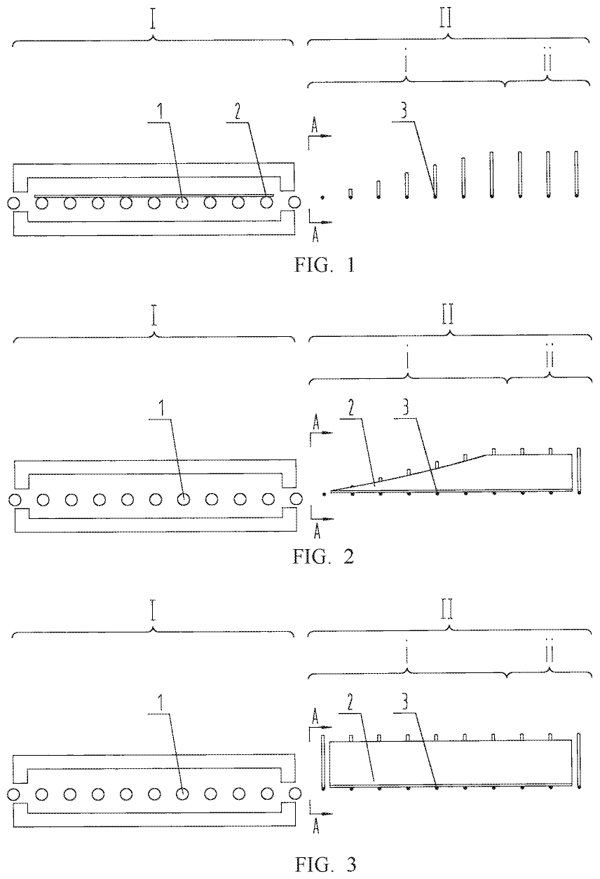

As shown in FIGS. 1, 2, 3, 4, 5, and 6. The method for producing single curved tempered glass is carried out using production device for producing a positive bending single curved tempered glass. The production device sequentially comprising a heating section I and a forming section II in accordance with a process sequence, wherein the heating section I is equipped with a ceramic roller table set 1, and the forming section II is equipped with a forming roller table set 3.

Said forming roller table set 3 comprises two portions: an upstream portion i close to the heating section I and a downstream portion ii away from the heating section I;

Said upstream portion i comprises n roller tables, which are respectively marked as the 1^{st}, 2^{nd}, 3^{rd}, . . . , n−1^{st}, n^{th} roller tables according to each roller table's distance from the heating section I from near to distant; the downstream portion ii comprises m roller tables, which are respectively marked as the 1^{st}, 2^{nd}, 3^{rd}, . . . , m−1^{st}, m^{th} roller tables according to each roller table's distance from the heating section I from near to distant; each roller table can be bent from an initial state to a final state;

The initial state of the 1^{st} roller table in the upstream portion i is straight and is parallel with ceramic roller tables in the ceramic roller table set 1 of the heating section I, and the initial state of the n^{th} roller table in the upstream portion i is bent so that an upper generatrix of the n^{th} roller table has fitted, or has not yet fitted, a shape of a lower surface of a product of the single curved tempered glass; the initial states of the 2^{nd}, 3^{rd}, . . . , n−1^{st} roller tables in the upstream portion i are respectively gradually changed from the initial state of the 1^{st} roller table to the n^{th} roller table in the upstream portion; the initial states of the 1^{st}, 2^{nd}, 3^{rd}, . . . , m−1^{st}, m^{th} roller tables in the downstream portion ii are the same as the initial state of the n^{th} roller table in the upstream portion i. The final states of the 1^{st}, 2^{nd}, 3^{rd}, . . . , n−1^{st}, and n^{th} roller tables and the final states of the 1^{st}, 2^{nd}, 3^{rd}, . . . , m−1^{st}, and m^{th} roller tables in the downstream portion ii are all bent so that an upper generatrix of each roller table has fitted the shape of the lower surface of the product of the single curved tempered glass;

The production method for producing single curved tempered glass comprising following steps:

Step 1) a heating process: that is, the glass 2 to be processed is heated in the heating section I to a temperature required by a glass bending and tempering process, and is softened;

Step 2) a transferring process: that is, the glass 2 softened after heating, under a jointly conveyance by the ceramic roller table set 1 of the heating section I and the forming roller table set 3 of the forming section II, enters the forming section II, in which each roller table in the upstream portion i and the downstream portion ii in its initial state; At the same time, the softened glass is closely appressed to an upper generatrix of each roller table in the upstream portion and the downstream portion under an action of gravity or other external force, and is pre-formed accordingly;

Step 3) a bending process: that is, each of the roller tables in said upstream portion i and the downstream portion ii is bent from its initial state to its final state, and the glass 2 softened after heating is closely appressed to the upstream portion i and the downstream portion ii under an action of gravity or other external force, and the glass softened after heating is formed accordingly;

Step 4) a cold quenching process: that is, cold quenching by blowing air, until the glass 2 is fully formed and is tempered, so as to obtain a product of single curved tempered glass.

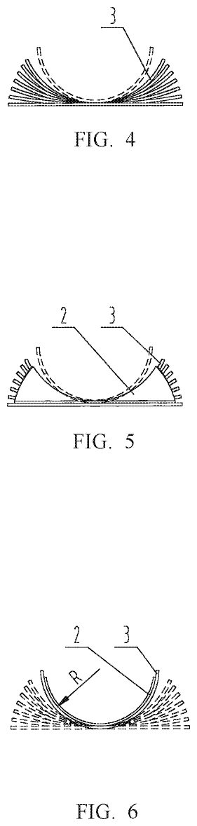

It should be noted in the drawings that the broken lines in FIGS. 4 and 5 illustrate the final state of each of the forming roller table sets 3; the broken lines in FIG. 6 illustrate the initial state of each of the roller table in forming roller table sets 3.

Said method for producing single curved tempered glass, wherein a length of the upstream portion i is not greater than 8000 mm.

A special embodiment of said production method of the single curved tempered glass: the number m of the m roller tables in the downstream portion ii is 0, that is, the forming roller table set 3 does not comprises the downstream portion ii, and only comprises the upstream portion i.

A special embodiment of said production method of the single curved tempered glass: if the product of the produced single curved tempered glass is a part of the cylindrical surface, wherein a radius of an outer circular surface in the cylindrical surface is R, then

The initial state of the n^{th} roller table in said upstream portion i, and the initial states of the 1^{st}, 2^{nd}, 3^{rd}, . . . , m−1^{st}, and m^{th} roller tables in the downstream portion ii are all bent so that an upper generatrix of each roller table is in a shape of an arc with a radius of r; The final states of the 1^{st}, 2^{nd}, 3^{rd}, . . . , n−1^{st}, and n^{th} roller tables in the upstream portion i, and the final states of 1^{st}, 2^{nd} 3^{rd} . . . , m−1^{st}, and m^{th} roller tables in the downstream portion ii, are all bent so that an upper generatrix of each roller table is in a shape of an arc with a radius of R, r is not smaller than R.

### The Second Embodiment

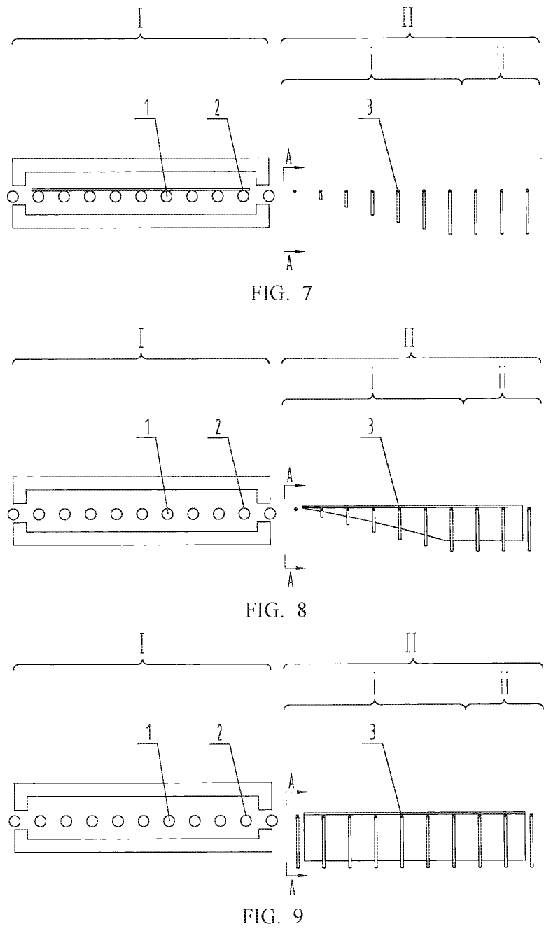

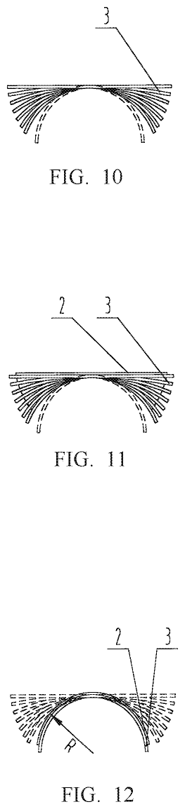

As shown in FIGS. 7, 8, 9, 10, 11, and 12. The invention discloses a reverse bending production method of single curved tempered glass with a production device of single curved tempered glass.

The difference from the first embodiment is that the two ends of the roller tables in the forming roller table set 3 are bent downwards, and the rest are the same as or similar to those in the first embodiment, and are not described herein.

The above description is intended to be illustrative, and not restrictive. It should be understood by those ordinary technicians skilled in the art of this field that many modifications, variations or equivalents may be made without departing from the spirit and scope of the present disclosure. However all the above will fall within the scope of protection of the present disclosure.

1. A production device for producing single curved tempered glass,
sequentially comprising a heating section and a forming section in accordance with a process sequence, wherein the heating section is provided with a ceramic roller table set, and the forming section is provided with a forming roller table set, wherein:
Said forming roller table set comprises an upstream portion close to the heating section, and a downstream portion farther away from the heating section;
Said upstream portion comprises n roller tables, which are respectively marked as the 1^{st}, 2^{nd}, 3^{rd}, . . . , n−1^{st}, and n^{th} roller tables according to a distance from the heating section from near to distant; the downstream section comprises m roller tables, which are respectively marked as the 1^{st}, 2^{nd}, 3^{rd}, . . . , m−1^{st}, and m^{th} roller tables according to a distance from the heating section from near to distant; each roller table can be bent from an initial state to the final state;
The initial state of the 1^{st} roller table in the upstream portion is straight and is parallel with ceramic roller tables in the ceramic roller table set of the heating section, and the initial state of the n^{th} roller table in the upstream portion is bent so that an upper generatrix of the n^{th} roller table has fitted, or has not yet fitted, a shape of a lower surface of a product of the single curved tempered glass; The initial states of the 2^{nd}, 3^{rd} . . . , and n−1^{st} roller tables in the upstream portion are respectively gradually transited from the initial state of the 1^{st} roller table in the upstream portion to the n^{th} roller table in the upstream portion; The initial states of the 1^{st}, 2^{nd}, 3^{rd}, . . . , m−1^{st}, and m^{th} roller tables in the downstream portion are all the same as the initial state of the n^{th} roller table in the upstream portion; the final states of the 1^{st}, 2^{nd}, 3^{rd}, . . . , n−1^{st}, and n^{th} roller tables in the upstream portions and the final states of the 1^{st}, 2^{nd}, 3^{rd}, . . . , n−1^{st}, and m^{th} roller tables are all bent so that an upper generatrix of each roller table has fitted the shape of the lower surface of the product of the single curved tempered glass.

2. The production device for producing single curved tempered glass according to claim 1, wherein a length of the upstream portion is not greater than 8000 mm.

3. The production device for producing single curved tempered glass according to claim 1, wherein the number m of the m roller tables in the downstream portion is 0, that is, the forming roller table set does not comprises the downstream portion, and only comprises the upstream portion.

4. The production device for producing single curved tempered glass according to claim 1, wherein the product of the single curved tempered glass is a part of a cylindrical surface, wherein a radius of an outer circular surface in the cylindrical surface is R; The initial state of the n^{th} roller table in the upstream portion, and the initial states of the 1^{st}, 2^{nd}, 3^{rd}, . . . , m−1^{st}, and m^{th} roller tables in the downstream portion are all bent so that an upper generatrix of each roller table is in a shape of an arc with a radius of r; the final states of the 1^{st}, 2^{nd}, 3^{rd}, . . . , n−1^{st}, n^{th} roller tables in the upstream portion, and the final states of the 1^{st}, 2^{nd}, 3^{rd}, . . . , m−1^{st}, m^{th} roller tables in the downstream portion, are all bent so that an upper generatrix of each roller table is in a shape of an arc with a radius of R; r is not smaller than R.

5. A production method for producing single curved tempered glass, applying the production device for producing single curved tempered glass according to claim 1, for a positive bending production or a reverse bending production, wherein the production method comprising following steps:
Step 1) heating: that is, a glass is heated in the heating section to a temperature required by a glass bending and tempering process, and is softened;
Step 2) transferring: that is, under a jointly conveyance by the ceramic roller table set of the heating section and the forming roller tables of the forming section, enter the forming section, in which each roller table in the upstream portion and the downstream portion is in its initial state; At the same time, under an action of gravity or other external force, the glass softened after heating is closely appressed to an upper generatrix of each roller table in the upstream portion and the downstream portion, and the glass softened after heating is preformed accordingly;
Step 3) bending: that is, each roller table in the upstream portion and the downstream portion is bent from its initial state to its final state; the glass softened after heating is closely appressed to the upper generatrix of each roller table in the upstream and downstream portions under an action of gravity or other external force, and the glass softened after heating is formed;
Step 4) cold quenching: that is, cold quenching by blowing air until the glass is fully formed and is tempered so as to obtain a product of single curved tempered glass.
